(19) United States
(12) Patent Application Publication
(10) Pub. No.: US 2026/0171469 A1
(43) Pub. Date: Jun. 18, 2026

(54) FUNCTIONAL BATTERY SEPARATOR

(71) Applicant: Soelect Inc., Greensboro, NC (US)

(72) Inventor: Sungjin Cho, Summerfield, NC (US)

(21) Appl. No.: 19/103,932

(22) PCT Filed: Aug. 14, 2023
(86) PCT No.: PCT/US2023/030159

§ 371 Date: Feb. 14, 2025

Related U.S. Application Data
(60) Provisional application No. 63/398,681, filed on Aug. 17, 2022.

(51) Int. Cl. H01M 10/052; H01M 10/0525; H01M 50/403; H01M 50/491

(52) U.S. Cl. CPC H01M 10/052; H01M 10/0525; H01M 50/403; H01M 50/491

(57) ABSTRACT

A functional battery separator including a bare separator component with a lithiophilic coating is disclosed. In particular, the lithiophilic coating is formed on a surface of the bare separator component, wherein the lithiophilic coating includes particles of an applied functional lithiophilic solution.

### CROSS-REFERENCE TO RELATED APPLICATIONS

This application claims priority to U.S. Provisional Ser. No. 63/398,681, filed on Aug. 17, 2022, the disclosure of which is incorporated herein by reference in its entirety.

### TECHNICAL FIELD

The present disclosure relates generally to rechargeable lithium-ion batteries, and more particularly to functional battery separator components utilized in lithium metal batteries.

### BACKGROUND

At present, lithium metal is largely considered by the battery manufacturing industry as the material of choice for use in the next generation of anodes due to its high capacity and engineering aspect. Notably, lithium metal can deliver a theoretical specific capacity of 3860 mAh/g and has the lowest redox potential of −3.04 volts (vs. a standard hydrogen electrode (SHE) reference). However, the use of lithium metal anodes presents several disadvantages that discourage further development, including its low Coulombic efficiency, poor battery cycle life, and poor thermal and electrochemical stability. These inherent disadvantages can be attributed to the high reactivity of lithium metal as well as the unfavorable formation of dendrites (i.e., small whiskers of metal) that typically occurs at the interface between the lithium metal electrode and electrolyte. For example, a severe side reaction occurring between lithium and the battery cell's electrolyte typically leads to irreversible consumption of the active lithium, which continues until a stable solid electrolyte interphase (SEI) is formed. However, if the conductivity of the SEI is inadequate, dendrites form on the surface of the lithium anode component. Notably, the formation of lithium dendrites at the anode that induces the production of dead lithium can ultimately cause an internal short circuit within the battery cell during cycling. Further, the physical isolation of lithium from the main lithium metal electrode also leads to degradation of a battery cell's capacity. Moreover, the continuous exposure of fresh lithium metal to an electrolyte solution may cause a continuous consumption of electrolyte material. This scenario eventually leads to a drastic increase in the internal resistance exhibited within the battery cell as well as the drying up of the electrode surface due to the diminished amount of electrolyte to cause failure.

### SUMMARY

A functional battery separator comprising a bare separator component with a lithiophilic coating is disclosed. In particular, the lithiophilic coating is formed on a surface of the bare separator component, wherein the lithiophilic coating includes particles of an applied functional lithiophilic solution.

According to at least one embodiment of the disclosed subject matter, the functional lithiophilic coating formed as a result of the applied functional lithiophilic solution drying on the surface of the bare separator component.

According to at least one embodiment of the disclosed subject matter, the particles of the lithiophilic coating originate from at least one functional lithiophilic material contained in the applied functional lithiophilic solution.

According to at least one embodiment of the disclosed subject matter, the at least one functional lithiophilic material includes lithium nitrate.

According to at least one embodiment of the disclosed subject matter, the at least one functional lithiophilic material includes a concentrations of 0.01M to 10M lithium nitrate in the solvent of the applied functional lithiophilic solution.

According to at least one embodiment of the disclosed subject matter, the at least one functional lithiophilic material includes one or more of: NaNO₃, CsNO₃, RbNO₃, LiNO₃, KNO₃, Ba(NO₃)₂, Sr(NO₃)₂, Mg(NO₃)₂. NH₄NO₃. Li₃AlN₂, Li₅SiN₃, Li₃BN₂, LiMgN, LiCaN, Li₂HfN₂, Li₃ScN₂, Li₂ZrN₂, Li₅TiN₃, Li₄TaN₃, Li—TaN₄, Li—NbN₄, Li₆WN₄, Li₇VN₄, and/or Li₁₈P₆N₁₆.

According to at least one embodiment of the disclosed subject matter, the at least one functional lithiophilic material includes an additive material (M) to form a compound LiₓMN_{y}, wherein M includes one of Al, Zn, Sn, In, Ba, Mg, Ni, Cu, Mn, Fe, Sb, Ge, Si, Ti, Co, Ag, Au, Pt, Ir, Ru, Zr, Te, Ca, B, and P.

According to at least one embodiment of the disclosed subject matter, the functional lithiophilic solution includes one or more of: lithium chloride (LiCl), lithium nitride (Li₃N), lithium dihydrogen phosphate (H₂LiO₄P), lithium tetrafluoroborate (LiBF₄), lithium hexafluorophosphate (LiPF₆), lithium hexafluoro-arsenate (LiAsF₆), lithium hexafluoroantimonate (LiSbF₆), lithium hexafluorotantalate (LiTaF₆), and lithium hexafluoroniobate (LiNbF₆), lithium trifluoromethanesulfonate (LiCF₃SO₃), lithium perfluorobutylsulfonate (LiC₄F₉SO₃), lithium bis(trifluoromethanesulfonyl)imide (LiC₂F₆NO₄S₂), lithium bis (perfluoro-ethane-sulfonyl)imide (Li(CF₃CF₂SO₂)₂N), lithium tris(trifluoromethanesulfonyl) methide (C₄F₉LiO₆S₃), lithium pentafluoroethyltrifluoroborate (LiBF₃(C₂F₅)), lithium bis(oxalato)borate (LiB(C₂O₄)₂), lithium tetra(pentafluorophenyl)borate(C₂₄BF₂₀Li), lithium fluoroalkylphosphate (LiPF₃(CF₃CF₂)₃), and/or lithium difluorophosphate, lithium(difluorooxalato) borate.

According to at least one embodiment of the disclosed subject matter, the fluorinated chemicals comprise one or more non-polar solvents that include methoxyperfuorobutane, 1,1,2,2-tetrafuoro-1-(2,2,2-trifuoroethoxy) ethane, and/or another non-polar solvent having non-flammable characteristics.

According to at least one embodiment of the disclosed subject matter, the bare separator component is a polymer membrane component comprising one or more of: polyethylene, poly propylene, a poly propylene tri-layer (PP/PE/PP), polyacrylonitrile (PAN), polyvinylidene difluoride (PVDF), polyethylene oxide (PEO), polyvinyl chloride (PVC), poly phthalate (PPh), polytetrafluoroethylene (PTFE), and/or poly imide (PI).

According to at least one embodiment of the disclosed subject matter, the bare separator component includes a non-woven based separator comprising one or more of: cellulose, lignin, polyethylene terephthalate (PET), polyester, polypropylene, cotton, nylon, and/or glass.

According to at least one embodiment of the disclosed subject matter, the bare separator component comprises a paper-based separator, a ceramic-based separator, or a composite-based separator.

The disclosed subject matter further includes a lithium-ion battery cell that comprises a cathode element, an anode element, and a lithiophilic functional battery separator component. The lithiophilic functional battery separator component comprises a bare separator component that is positioned in between the cathode element and the anode element and includes a lithiophilic coating containing particles of an applied functional lithiophilic solution.

According to at least one embodiment of the disclosed subject matter related to the lithium-ion battery cell, the anode element comprises lithium metal.

According to at least one embodiment of the disclosed subject matter, the functional lithiophilic coating formed as a result of the applied functional lithiophilic solution drying on the surface of the bare separator component.

According to at least one embodiment of the disclosed subject matter related to the lithium-ion battery cell, the particles of the lithiophilic coating originate from at least one functional lithiophilic material contained in the applied functional lithiophilic solution.

According to at least one embodiment of the disclosed subject matter related to the lithium-ion battery cell, the at least one functional lithiophilic material includes lithium nitrate.

According to at least one embodiment of the disclosed subject matter related to the lithium-ion battery cell, the at least one functional lithiophilic material includes a concentrations of 0.01M to 10M lithium nitrate in the solvent of the applied functional lithiophilic solution.

According to at least one embodiment of the disclosed subject matter related to the lithium-ion battery cell, the at least one functional lithiophilic material includes one or more of: NaNO₃, CsNO₃, RbNO₃, LiNO₃, KNO₃, Ba(NO₃)₂, Sr(NO₃)₂, Mg(NO₃)₂. NH₄NO₃. Li₃AlN₂, Li₅SiN₃, Li₃BN₂, LiMgN, LiCaN, Li₂HfN₂, Li₃ScN₂, Li₂ZrN₂, Li₅TiN₃, Li₄TaN₃, Li₇TaN₄, Li₇NbN₄, Li₆WN₄, Li₇VN₄, and/or Li₁₈P₆N₁₆

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 illustrates a schematic of a solution N direct deposition spraying process on a battery separator component in accordance with embodiments described herein;

FIG. 2 illustrates the schematic of a solution N direct deposition casting process on a battery separator component in accordance with embodiments described herein;

FIG. 3 illustrates a schematic of an example structure of solid electrolyte interphase (SEI) formation on battery separator in accordance with embodiments described herein;

FIG. 4 is a graphical representation of the cycling performance of full cells made with an example functional battery separator (SPP25-PFS2) at 1C/1C rate in accordance with embodiments described herein;

FIG. 5 is a graphical representation of the capacity retention of an example functional battery separator (SPP25-PFS2) at 1C/1C rate in accordance with embodiments described herein;

FIG. 6 is a graphical representation of the cycling performance of full cells made with an example functional battery separator (PP11-PFS2) at 1C/1C rate in accordance with embodiments described herein; and

FIG. 7 is a graphical representation of the capacity retention of an example functional battery separator (PP11-PFS2) at 1C/1C rate in accordance with embodiments described herein;

FIG. 8 illustrates a block diagram of an example full battery cell in accordance with embodiments described herein.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

Many technical approaches used in the rechargeable battery manufacturing industry, such as artificial SEI construction, solid-state electrolyte design, electrolyte engineering, and 3D composite lithium metal anode construction, have been previously introduced in an attempt to address and remedy the lithium dendrite growth problem. While advancements have been made, there are no currently practiced solutions that are both cost effective and environmentally friendly. Difficulties largely arise from the fact that it is not straightforward to apply modifications and coatings directly on the lithium metal due to the material's chemical and physical properties. As such, modifications to other battery cell components offer more promising results. For example, separator modification may be used to address lithium dendrite formation since techniques can be leveraged to inhibit dendrite growth without significantly increasing the weight and volume of the battery. Notably, successful improvements to the separator will minimize the detrimental impacts on the energy density of a rechargeable battery cell. Moreover, modification of a separator component is less difficult to accomplish as compared to processing/modifying lithium metal. In addition, the ability to mass produce separator components on a large scale is a more cost-effective process.

In many instances, a modified separator component can inhibit lithium dendrite growth due to its uniform lithium ion (Li⁺) flux through an enhanced solid electrolyte interface driven by a functional coating on separator, and its mechanical ductility. Inhomogeneous deposition of lithium can cause increased local nucleation and lithium growth at high concentration spots on the anode, which leads to dendrite formation and the failure of a separator. To effectively address this issue, regulating lithium-ion deposition to promote homogeneous nucleation is essential. Therefore, coating a separator with a lithiophilic material that exhibits good ionic conductivity and diffusion is an effective method for suppressing dendrite growth and its localization. As used herein, the term lithiophilic refers to a material (e.g., element, compound, solution, etc.) that has an affinity to receive, diffuse with, and/or be combined with lithium. Specifically, use of a lithiophilic material can provide fast and uniform diffusion pathways for lithium-ion transportation, which may assist with achieving a homogeneous lithium ion flux on the anode surface. This also allows for lithium deposition within a rechargeable battery cell that is uniform and dendrite-free. In particular, the disclosed subject matter pertains to a functional battery separator that is produced by applying a lithiophilic ‘N solution,’ such as a lithium nitrate material (or any other nitride material), on a separator component using one or more application methods, such as direct nitrate solution casting, spraying, and/or electrostatic deposition (ESD).

In some embodiments, the lithiophilic N solution may include functional material including one or more of the compounds comprising: LiNO₃, NaNO₃, CsNO₃, RbNO₃, KNO₃, Ba(NO₃)₂, Sr(NO₃)₂, Mg(NO₃)₂, NH₄NO₃. Li₃AlN₂, Li₅SiN₃, Li₃BN₂, LiMgN, LiCaN, Li₂HfN₂, Li₃ScN₂, Li₂ZrN₂, Li₅TiN₃, Li₄TaN₃, Li₇TaN₄, Li₇NbN₄, Li₆WN₄, Li₇VN₄, and/or Li₁₈P₆N₁₆.

Alternatively, the functional material in the lithiophilic N solution may include a metal oxide material to form LiₓMN_{y}, wherein the metal oxide material (‘M’) includes at least one of Al, Zn, Sn, In, Ba, Mg, Ni, Cu, Mn, Fe, Sb, Ge, Si, Ti, Co, Ag, Au, Pt, Ir, Ru, Zr, and/or Te, and wherein the subscript ‘x’ represents stoichiometry of lithium and the subscript ‘y’ represents the stoichiometry of nitrogen in the compound expression LiₓMN_{y}. In some embodiments, the material ‘M” may instead represent a non-metallic material like B and P.

In other embodiments, the functional material in the lithiophilic N solution may comprise a lithium compound including lithium chloride (LiCl), lithium nitride (Li₃N), lithium dihydrogen phosphate (H₂LiO₄P), lithium tetrafluoroborate (LiBF₄), lithium hexafluorophosphate (LiPF₆), lithium hexafluoro-arsenate (LiAsF6), lithium hexafluoroantimonate (LiSbF₆), lithium hexafluorotantalate (LiTaF₆), and lithium hexafluoroniobate (LiNbF₆), lithium trifluoromethanesulfonate (LiCF₃SO₃), lithium perfluorobutylsulfonate (LiC₄F₉SO₃), lithium bis(trifluoromethanesulfonyl)imide (LiC₂F₆NO₄S₂), lithium bis (perfluoro-ethane-sulfonyl)imide (Li(CF₃CF₂SO₂)₂N), lithium tris(trifluoromethanesulfonyl) methide (C₄F₉LiO₆S₃), lithium pentafluoroethyltrifluoroborate (LiBF₃(C₂F₅)), lithium bis(oxalato)borate (LiB(C₂O₄)₂), lithium tetra(pentafluorophenyl)borate(C₂₄BF₂₀Li), lithium fluoroalkylphosphate (LiPF₃(CF₃CF₂)₃), lithium difluorophosphate, and/or lithium(difluorooxalato) borate.

As an example, the disclosed subject matter is directed to the use of lithium nitrate (i.e., LiNO₃) as N material because the nitrate ion exhibits a higher decomposition potential (e.g., approximately 1.7 volts vs. the Li+ ion) when compared to any other carbonate electrolyte and/or several polymer/lithium salt composites. However, the lithiophilic N solution (being a nitrate solution) exhibits a very low dissolution in any carbonate solution due to having a lower donor number (DN). A number of approaches have been tried to improve this solubility limitation, such as using a polymer electrolyte or an ether-based electrolyte with the nitrate additive (i.e., lithiophilic N solution). However, these approaches have limited applications for conventional lithium ion batteries using carbonate-based electrolytes. Notably, the techniques associated with the disclosed subject matter are the best way to improve the solubility of lithium nitrate being subjected/applied to battery cycling, especially with the use of lithium metal anodes. The disclosed subject matter also affords the most cost-effective and efficient way to significantly advance the lithium metal anode performance.

In some embodiments, the disclosed subject matter relates to a functional battery separator that may be configured for use with a rechargeable battery anode. Although the following description herein pertains to a lithium metal anode, it is understood that the disclosed subject matter may utilize any anode material compatible for a lithium-ion battery (e.g., a lithium-ion battery, a solid-state lithium-ion battery, or any other alkali metal battery or alkaline earth metal battery). In some embodiments, the functional battery separator disclosed herein may comprise one or more nitride material(s) that can be used to form an artificial solid electrolyte interface (SEI) and/or an electrical insulator. Further, the disclosed functional battery separator includes a lithium nitrate solution, which is capable of promoting an efficient and stable cycle life with a lithium metal anode (e.g., for long-term cycle life) since the protective interfacial layer on the separator that is formed can reduce the interfacial resistance existing between the functional battery separator and the anode surface.

In some embodiments, the disclosed subject matter involves the use of a polyolefin-based battery separator as a base component for the functional battery separator. Exemplary polyolefin-based battery separators may include, but are not limited to, polyethylene, poly propylene and its tri-layer (e.g., PP/PE/PP). The disclosed subject matter may also include separator materials such as polyvinylidene fluoride (PVDF), polyimide (PI), polyacrylonitrile (PAN), polytetrafluoroethylene (PTFE), and/or any non-woven materials. For example, a separator including non-woven materials may comprise one or more of cellulose, lignin, polyethylene terephthalate (PET), polyester, polypropylene, cotton, nylon, glass, and others.

Further, the functional battery separator may also comprise a paper-based separator, a ceramic-based separator, or a composite-based separator.

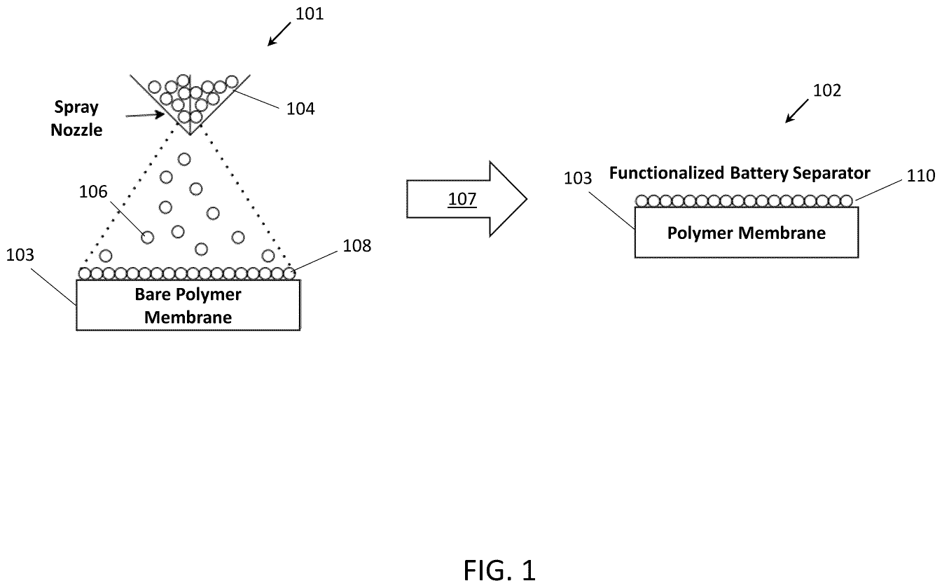

With reference to FIGS. 1-7, the one or more functional battery separators of the disclosed subject matter includes at least a portion of lithium nitrate (e.g., the N-solution). Although the following description for each of FIGS. 1-7 reference the utilization of a lithium nitrate solution, it is understood that other combinations of lithium salts and/or polymers can be applied in a similar manner without departing from the scope of the disclosed subject matter.

FIG. 1 depicts a schematic of a direct deposition system 100 configured to apply a lithiophilic N solution on a battery separator component 103. For example, FIG. 1 illustrates a battery separator component 103 (e.g., a bare polymer membrane) that is positioned underneath a spray nozzle element 104 such that the deposition system 100 is permitted to spray and deposit particles and/or droplets of lithiophilic N solution 106 onto the surface of a bare battery separator 103. In some embodiments, battery separator 103 component may include either a bare 11 μm thick polypropylene (PP11) polymer battery separator, a bare 20 μm thick polypropylene (PP20) polymer battery separator, a bare 25 μm thick surfactant coated polypropylene (SPP25) polymer battery separator, and/or the like. Although bare battery separator component 103 is depicted as a polymer membrane in FIG. 1, other types of separator components, such as a non-woven separator component, a ceramic-based separator component, a paper-based separator component, a composite-based separator component, and the like may be utilized without departing from the scope of the disclosed subject matter.

Once the lithiophilic N solution 101 is deposited on the separator 103 (i.e., as uniformly deposited lithiophilic N solution 108), it may be permitted to dry out (see arrow 107 in FIG. 1) thoroughly to allow for the removal of moisture and solvent contents. As shown in FIG. 1, a functional battery separator 102 that includes a uniform layer of dried lithiophilic N solution coating 110 is obtained. In some embodiments, deposited lithiophilic N solution 108 (which when dried forms coating 110) may include a lithium nitrate solution that has a lower solubility in many solvents. For example, lithiophilic N solution may comprise a 0.1M˜4M LiNO₃ solution mixed in ethanol.

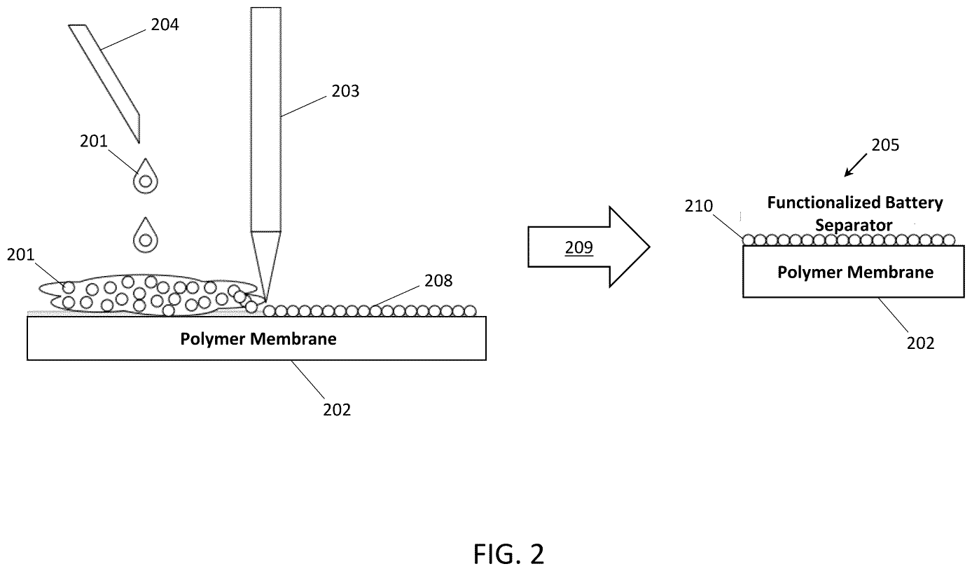

In other embodiments, the lithiophilic N solution can be deposited and applied on the polymer battery separator using a pipette and blade implement (e.g., a scalpel or other like tool/instrument). Notably, FIG. 2 illustrates an example casting technique by which the lithiophilic N solution can be applied to the separator. Notably, the lithiophilic N solution (e.g., lithium nitrate solution) has a low solubility in many solvents. In this example scenario, a polymer-based lithium salt solution with ethylene carbonate (EC) as a solvent is used. For example, FIG. 2 depicts a pipette 204 containing a lithiophilic N solution that is positioned over a battery separator component 202. The pipette 204 may be used to administer a number of droplets and/or particles of lithiophilic N solution 201 onto the surface of separator component 202. In some embodiments, battery separator component 202 may include a bare 11 μm thick polypropylene (PP11) polymer battery separator, a bare 20 μm thick polypropylene (PP20) polymer battery separator, a bare 25 μm thick surfactant coated polypropylene (SPP25) polymer battery separator, or the like. Although bare battery separator component 202 is depicted as a polymer membrane in FIG. 2, other types of separator components, such as a non-woven separator component, a ceramic-based separator component, a paper-based separator component, a composite-based separator component, and the like, may be utilized without departing from the scope of the disclosed subject matter.

After being cast on the separator 202, a blade implement 203 (e.g., scalpel or other like precision bladed tool) may be used to uniformly distribute the particles and/or droplets of the lithiophilic N solution over the surface of separator 202. Notably, a uniform layer 208 of lithiophilic N solution is formed. After uniformly distributing the applied with the lithiophilic N solution on the surface of separator 202, the lithiophilic N solution 201 (e.g., a lithium salt and/or polymer composite) is then permitted to dry out (see arrow 209 in FIG. 2) thoroughly to remove any moisture and solvent contents) that results in a lithiophilic N-component coating 210 (i.e., lithium salt and/or polymer composition coating) remaining on the surface of separator 202, thereby producing a functional battery separator 205.

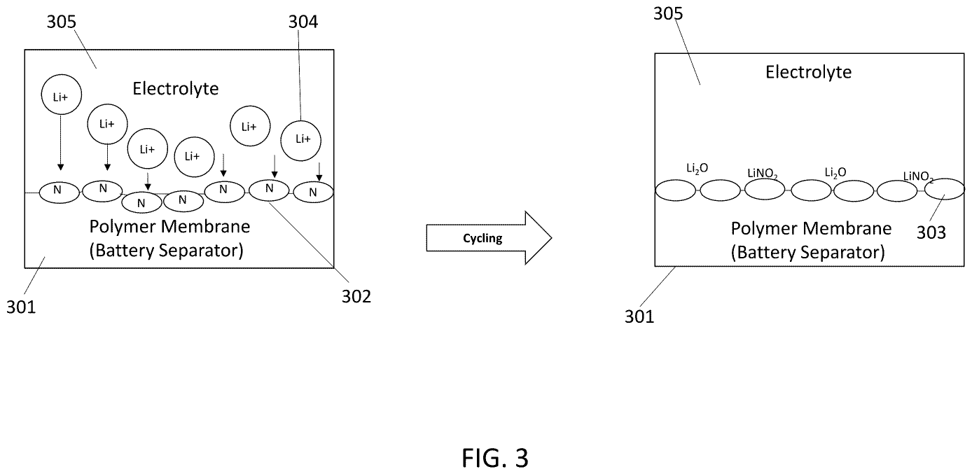

FIG. 3 illustrates a schematic of an example structure of solid electrolyte interphase (SEI) formation on battery separator in accordance with embodiments described herein. For example, FIG. 3 illustrates coated N particles 302 on the surface of a functional battery separator 301 (e.g., of a full lithium metal battery cell) that has been subjected to repeated battery charging/discharging cycles. During cycling, the Li⁺ ions 304 are released from the cathode component while charging and move through the liquid electrolyte 305 and gradually react with electrolytes to form Li₂O, LiF and LiₓN_{y}O_{z} 303. Each of these resultant compounds are highly ionically conductive and further promote an increase in battery cycle life due to the reduction of dendrites (e.g., by promoting homogeneous deposition of lithium via plating). For example, lithium nitrate will transform to LiₓN_{y}O_{z} (where x, y, z is a stoichiometric ratio and×is typically equal to ‘1”) and become a lithium ionic compound which facilitates the lithium ion transfer to the anode without additional lithium depletion in the outer surface of anode.

The functional battery separator(s) of the disclosed subject matter can be prepared using several methods and techniques. A number of methods, which are intended as examples and in no way limit the scope of the disclosed subject matter, are presented below.

### Example 1: Preparation of a Lithium Salt Functional Battery Separator (FS1) [LiNO₃, C₂H₅OH]

In one example, the following materials were used for the synthesis of a functional battery separator coating: lithium nitrate (LiNO₃, Fischer Scientific) and ethanol (C₂H₅OH, Carolina Biological Supply).

In a dry room environment or Ar-filled glovebox atmosphere, with relative humidity level less than 0.5%, a solution of LiNO₃ is prepared with anhydrous ethanol as the solvent in 1M-4M molarities (of the solution) by constantly stirring at 400 revolutions per minute (rpm) with a magnetic stir bar for two hours to produce the lithiophilic N solution. The LiNO₃ powder was milled in a planetary ball mill at 650 rpm for 15 minutes and dried at 80° C. for 16 hours before mixing. In addition, an 11 micrometer (μm ) thick polypropylene portion is obtained and trimmed to form an 8 centimeter (cm)×8 cm polypropylene separator (e.g., PP11 separator).

Likewise, a 20 μm thick polypropylene portion is obtained and trimmed to form an 8 cm×8 cm polypropylene separator (e.g., PP20 separator). Similarly, a 25 μm thick surfactant-coated polypropylene portion is obtained and trimmed to form an 8 cm×8 cm polypropylene separator (e.g., SPP25 separator).

Afterwards, the three trimmed polypropylene separators are each placed completely flat on a glass plate without exhibiting any wrinkles and/or folding. The prepared lithiophilic N solution (e.g., 1-4 mL) is then sprayed (or dropped using a pipette) on the prepared PP11, PP 20 and SPP25 separators. The applied lithiophilic N solution is then cast uniformly over the entire area of each separator area using a blade implement (e.g., a scalpel or other like precision bladed tool), such that the thickness of the N solution coating is approximately 25 μm . The functional materials coated separators were dried under room temperature in a dry room environment for two hours. Once fully dried, the functional battery separators (i.e., separators with a dried N-solution coating) PP11-FS₁, PP20-FS₁, and SPP25-FS1 are produced.

### Example 2. Synthesis of a Polymer Composite Coating Functional Battery Separator (P-FS₁), [SEM: PAN, EC, LiPF₆, GN]

In one example, the following materials were used for synthesis of a functional battery separator coating: polyacrylonitrile (PAN, MW 150,000, Sigma Aldrich), ethylene carbonate (EC, Aldrich), lithium hexafluorophosphate (LiPF₆, Aldrich), and glutaronitrile (GN, TCI America).

In an argon filled glovebox, a solution was initially prepared by melting ethylene carbonate in a glass beaker on top of a hot plate at 70° C. with constant stirring at 60 rpm by a magnetic stir bar. Further, 5-6 wt % (percentage by weight) PAN was added to the solution in a gradual manner. In order to achieve complete dissolution of the PAN, the mixture was stirred for two hours. When the PAN was fully dissolved in the solution, 6-7 wt % of lithium salt (e.g., LiPF₆) was added to the solution and stirred for 90 minutes at 80° C. and constantly stirred at 60 rpm. Afterwards, 20 wt % amount of glutaronitrile was added to the mixture and further stirred at 120 rpm for 30 minutes at 80° C. to homogenize the solution.

In addition, an 11 μm thick polypropylene portion is obtained and trimmed to form an 8 centimeter (cm)×8 cm polypropylene separator (e.g., PP11 separator). Similarly, an 11 um thick polypropylene portion is obtained and trimmed to form an 8 cm×8 cm polypropylene separator (e.g., PP20 separator). Likewise, a 25 μm thick surfactant-coated polypropylene portion is obtained and trimmed to form an 8 cm×8 cm polypropylene separator (e.g., SPP25separator). Afterwards, the three trimmed polypropylene separators are each placed completely flat on a glass plate without exhibiting any wrinkles and/or folding. The prepared composite (e.g., lithiophilic N solution) solution (e.g., 1-4 mL) is then dropped on the prepared PP 11, PP20, and SPP25 separators using a pipette. The applied lithiophilic N solution is then cast uniformly over the entire area of each separator area using a blade implement (e.g., a scalpel or other like tool) such that the thickness of the N solution coating is approximately 25 um. Each of the three lithiophilic N solution coated separators were allowed to rest in the glovebox for 1 hour and then dried under vacuum conditions at 70° C. for three hours. Once fully dried, the functional battery separators (i.e., separators with a dried N-solution coating) PP11-PFS₁, PP20-PFS₁, and SPP25-PFS₁ are produced.

### Example 3. Synthesis of a Lithium Salt/Polymer Mixture Coating Functional

Battery Separator (P-FS2), [SEM: PAN, EC, LiPF₆, GN, LiNO₃] In one example, the following materials were used for synthesis of a functional battery separator coating: Polyacrylonitrile (PAN, MW 150,000, Sigma Aldrich), Ethylene Carbonate (EC, Aldrich), Lithium Hexafluorophosphate (LiPF₆, Aldrich), Glutaronitrile (GN, TCI America) and Lithium Nitrate (LiNO₃, Fischer Scientific).

In an argon filled glovebox, a solution was initially prepared by melting ethylene carbonate in a glass beaker on top of a hot plate at 70° C. with constant stirring at 60 rpm by a magnetic stir bar. In addition, 5-6 wt % PAN was gradually added to the solution. In order to achieve complete dissolution of the PAN, the mixture was stirred for two hours. When the PAN was fully dissolved in the solution, 6-7 wt % of lithium salt (e.g., LiPF₆) was added to the solution and stirred at 60 rpm for 90 minutes at 80° C. Further, a 20 wt % amount of glutaronitrile was added to the mixture and further stirred at 120 rpm for 30 minutes to homogenize the solution. Lastly, 1-3 wt % of lithium nitrate (i.e., LiNO₃) powder was added to the solution and stirred for another hour at 120 rpm to fully dissolve the powder in the lithiophilic solution. Notably, the LiNO₃ powder is initially milled in a planetary ball mill at 650 rpm for 15 minutes and dried at 80° C. for 16 hours prior to mixing in the solution.

In addition, an 11 μm thick polypropylene portion is obtained and trimmed to form an 8 centimeter (cm)×8 cm polypropylene separator (e.g., PP11 separator). Similarly, an 11 μm thick polypropylene portion is obtained and trimmed to form an 8 cm×8 cm polypropylene separator (e.g., PP20 separator). Likewise, a 25 μm thick surfactant-coated polypropylene portion is obtained and trimmed to form an 8 cm×8 cm polypropylene separator (e.g., SPP25 separator). Afterwards, the three trimmed polypropylene separators are each arranged completely flat on a glass plate without exhibiting any wrinkles and/or folding. Droplets of the prepared polymer/lithium salt composite (e.g., lithiophilic N solution) solution (e.g., 2 mL) is then placed on the prepared PP11, PP20, and SPP25 separators using a pipette. The applied lithiophilic N solution is then cast and/or spread uniformly over the entire area of each separator area using a blade implement (e.g., a scalpel or other like tool), such that the thickness of the N solution coating is approximately 25 μm. Each of the three lithiophilic N solution coated separators are then allowed to rest in the glovebox for 1 hour and subsequently dried under vacuum conditions at 70° C. for three hours. Once fully dried, the functional battery separators (i.e., separators with a dried N-solution coating) PP11-PFS2, PP20-PFS2, and SPP25-PFS2 are produced.

### Example 4: Preparation of a Lithium Battery Full Cell with FS 1 Separator (LB-FS 1)

In some embodiments, one or more of the functional battery separators described herein may be utilized as a component of a full lithium battery cell. For example, a plurality of coin cells 2032 were assembled using the functional battery separator (SSP25) prepared as described in example 1. A cathode element (LiNi_{0.8}Co_{0.1}Mn_{0.1}O₂ or NMC811), an anode element (e.g., a lithium metal anode) are combined with the SSP25 separator and a 1M LiPF₆ electrolyte solution comprising an ethylene carbonate (EC): diethyl carbonate (DEC) [1:2, v:v] solvent to construct the battery cell.

For example, a SPP25 separator is coated with a lithium salt/polymer solution that includes 1 wt % LiNO₃ in order to construct the functional battery separator SPP25-FS2. Notably, the coated side of the functional battery separator is positioned to face the lithium anode surface in the full battery cell. The battery cell (i.e., LB-SPP25-PFS2) is constructed in an argon filled glovebox with oxygen and moisture levels below 0.5 parts per million (ppm) and cycled at a 0.1C rate for the formation cycle and cycled at 1C/1C rates for the remainder of the cycles at room temperature (e.g., approximately 20-22° C.) within a voltage range of 3 -4.3 volts (V) versus Li/Li⁺ following a CCCV (i.e., Constant Current, Constant Voltage) protocol.

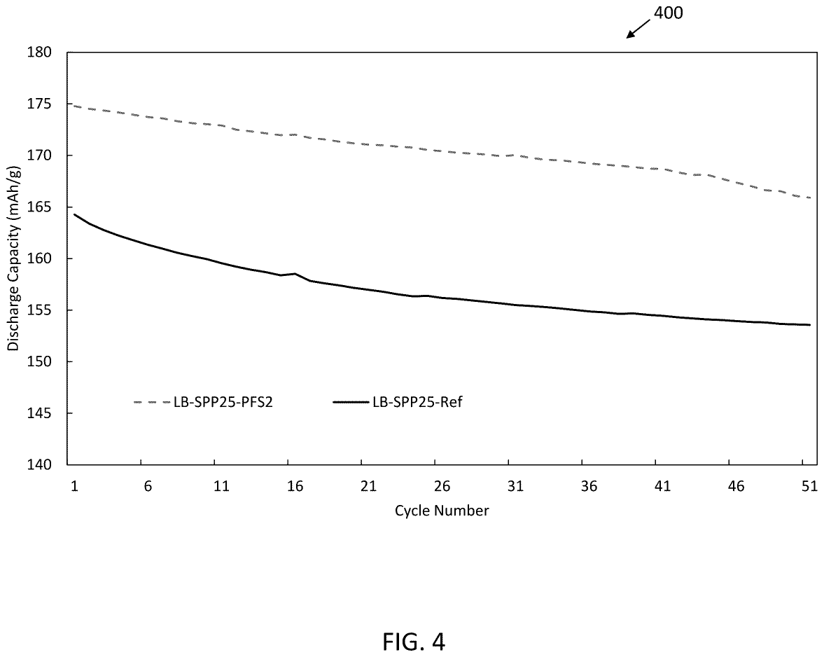

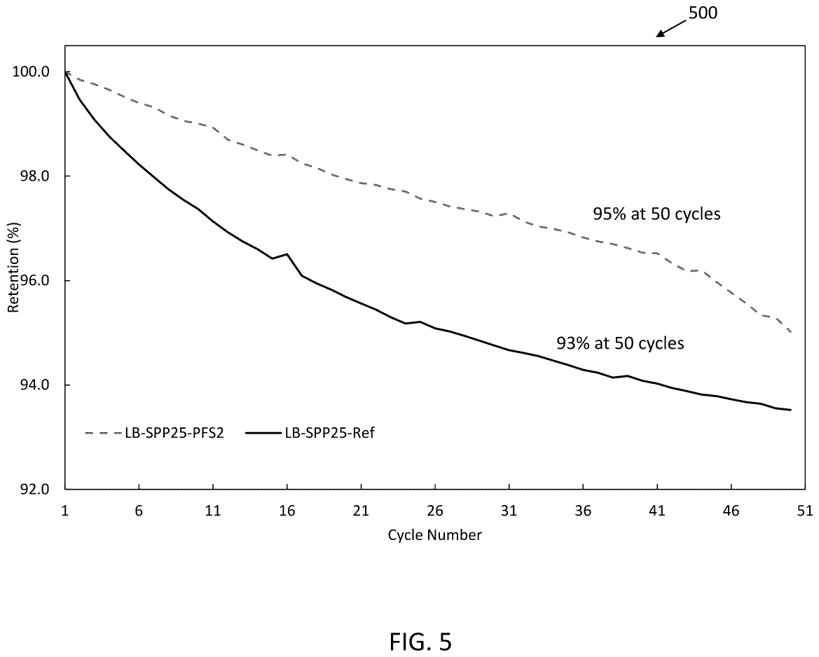

FIG. 4 depicts a graph 400 that illustrates the cycling performance of a full lithium battery cell LB-SPP25-PFS2 (i.e., lithium battery with SPP25 separator coated with PFS2) at 1C rate as compared to a reference cell, LB-SPP25-Ref, made with bare SPP25 separator. Notably, the cell with the functional battery separator demonstrated a first cycle discharge capacity of 195 mAh/g with a Coulombic efficiency (CE) of 88% as compared to a discharge capacity of 188 mAh/g and an 82.2% CE exhibited by the battery cell that is equipped with the bare SPP25 separator. The cell with the lithiophilic functional battery separator also exhibited a better capacity retention of 95% at 50 cycles compared to 93% of the reference cells at same number of cycles as shown in graph 500 depicted in FIG. 5.

### Example 5: Preparation of Lithium Battery Full Cell with PP 11-PFS2 Separator (LB-PP11-PFS2)

In some embodiments, coin cells 2032 were assembled using the lithiophilic functional battery separator (PP 11-PFS2), which was prepared as described above in Example 3. The coin cells were constructed with a cathode element (LiNi_{0.8}Co_{0.1}Mn_{0.1}O₂ or NMC811) and lithium metal anode in a 1 M LiPF₆ electrolyte solution, which includes an ethylene carbonate (EC): diethyl carbonate (DEC) [1:2, v:v] solvent. The PP11 separator was coated with a lithiophilic N solution (i.e., lithium salt/polymer solution) containing a 1 wt % LiNO₃ salt solute, which was applied to a bare PP11 separator to form the functional battery separator PP11-PFS2 (after the solvent dried). The PP11-PFS2 was then positioned in the full battery cell with its coated side facing the lithium anode surface. The cell (i.e., LB-PP11-PFS2) was made in an argon filled glovebox with oxygen and moisture levels below 0.5ppm and cycled at 0.1C for the formation cycle and 1C/1C rates for the remaining cycles at room temperature within a voltage range of 3-4.3V vs Li/Li⁺ following a CCCV protocol.

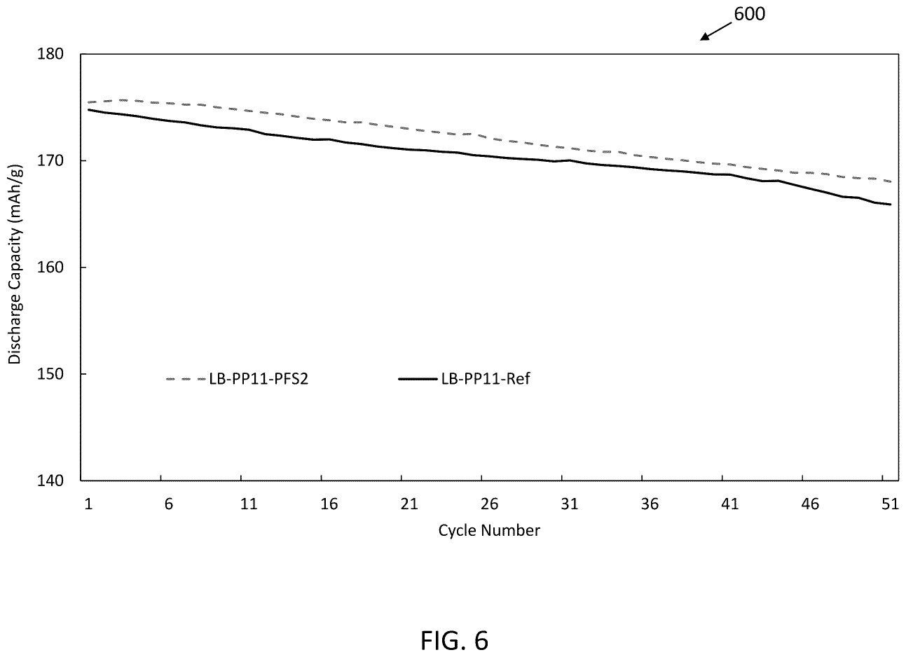

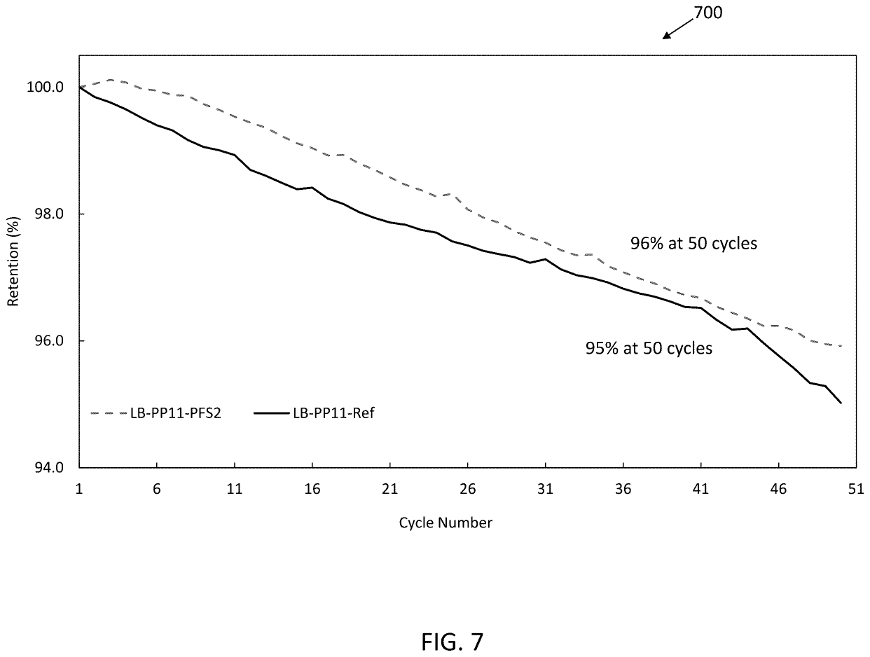

FIG. 6 depicts a graph 600 that illustrates cycling performance of the full lithium battery cell LB-PP 11-PFS2 (i.e., lithium battery with PP11 separator coated with PFS2) at a 1C rate compared to reference cell LB-PP11-Ref made with bare PP11 separator. The cell showed a first cycle discharge capacity of 194 mAh/g with Coulombic efficiency of 89% as compared to a capacity of 193 mAh/g and 90% CE displayed by the reference battery cell constructed with a bare PP11 separator. The cell with the lithiophilic functional battery separator also exhibited a better capacity retention of 96% at 50 cycles compared to 95% of the reference cells at same number of cycles as shown in graph 700 depicted in FIG. 7.

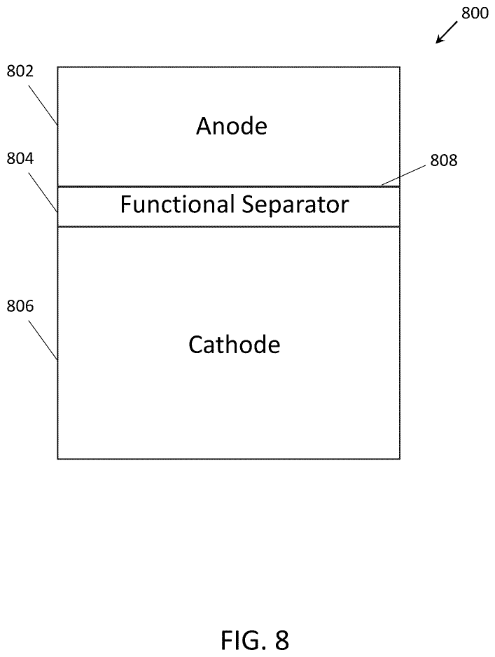

FIG. 8 illustrates an example of a full lithium battery cell 800 that includes a cathode element 806, an anode element 802, and a functional battery separator component 804. The functional battery separator component 804 is positioned in between the cathode element 806 and anode element 802 and has a lithiophilic coated surface facing the anode element 802 at interface 808. Notably, the lithiophilic coating on the separator component 804 may contain particles of any of the applied functional lithiophilic solutions described herein. It is understood that the cathode element 806, an anode element 802, and a functional battery separator component 804 of battery cell 800 as shown in FIG. 8 are not depicted to scale.

The embodiments shown and described in the preceding description are for illustration and explanation only and are not intended to limit the scope of the disclosed subject matter as set forth in the appended claims.

What is claimed is:

1. A functional battery separator comprising:
a bare separator component; and
a lithiophilic coating formed on a surface of the bare separator component, wherein the lithiophilic coating includes particles of an applied functional lithiophilic solution.

2. The functional battery separator of claim 1 wherein the functional lithiophilic coating formed as a result of the applied functional lithiophilic solution drying on the surface of the bare separator component.

3. The functional battery separator of claim 2 wherein the particles of the lithiophilic coating originate from at least one functional lithiophilic material contained in the applied functional lithiophilic solution.

4. The functional battery separator of claim 3 wherein the at least one functional lithiophilic material includes lithium nitrate.

5. The functional battery separator of claim 4 wherein the at least one functional lithiophilic material includes a concentrations of 0.01M to 10M lithium nitrate in the solvent of the applied functional lithiophilic solution.

6. The functional battery separator of claim 3 wherein the at least one functional lithiophilic material includes one or more of: NaNO₃, CsNO₃, RbNO₃, LiNO₃, KNO₃, Ba(NO₃)₂, Sr(NO₃)₂, Mg(NO₃)₂, NH₄NO₃, Li₃AlN₂, Li₃SiN₃, Li₃BN₂, LiMgN, LiCaN, Li₂HfN₂, Li₃ScN₂, Li₅ZrN₂, Li₅TiN₃, Li₄TaN₃, Li₇TaN₄, Li₇NbN₄, Li₆WN₄, Li₇VN₄, and/or Li₁₈P₆N₁₆.

7. The functional battery separator of claim 3 wherein the at least one functional lithiophilic material includes an additive material (M) to form a compound LiₓMN_{y}, wherein M includes one of Al, Zn, Sn, In, Ba, Mg, Ni, Cu, Mn, Fe, Sb, Ge, Si, Ti, Co, Ag, Au, Pt, Ir, Ru, Zr, Te, Ca, B, and P.

8. The functional battery separator of claim 3 wherein the functional lithiophilic solution includes one or more of: lithium chloride (LiCl), lithium nitride (Li₃N), lithium dihydrogen phosphate (H₂LiO₄P), lithium tetrafluoroborate (LiBF₄), lithium hexafluorophosphate (LiPF₆), lithium hexafluoro-arsenate (LiAsF6), lithium hexafluoroantimonate (LiSbF₆), lithium hexafluorotantalate (LiTaF₆), and lithium hexafluoroniobate (LiNbF₆), lithium trifluoromethanesulfonate (LiCF₃SO₃), lithium perfluorobutylsulfonate (LiC₄F₉SO₃), lithium bis(trifluoromethanesulfonyl)imide (LiC₂F₆NO₄S₂), lithium bis (perfluoro-ethane-sulfonyl)imide (Li(CF₃CF₂SO₂)₂N), lithium tris(trifluoromethanesulfonyl) methide (C₄F₉LiO₆S₃), lithium pentafluoroethyltrifluoroborate (LiBF₃(C₂F₅)), lithium bis(oxalato)borate (LiB(C₂O₄)₂), lithium tetra(pentafluorophenyl)borate(C₂₄BF₂₀Li), lithium fluoroalkylphosphate (LiPF₃(CF₃CF₂)₃), and/or lithium difluorophosphate, lithium(difluorooxalato) borate.

9. The functional battery separator of claim 8 wherein the fluorinated chemicals comprise one or more non-polar solvents that include methoxyperfuorobutane, 1,1,2,2-tetrafuoro-1-(2,2,2-trifuoroethoxy)ethane, and/or another non-polar solvent having non-flammable characteristics.

10. The functional battery separator of claim 1 wherein the bare separator component is a polymer membrane component comprising one or more of: polyethylene, poly propylene, a poly propylene tri-layer (PP/PE/PP), polyacrylonitrile (PAN), polyvinylidene difluoride (PVDF), polyethylene oxide (PEO), polyvinyl chloride (PVC), poly phthalate (PPh), polytetrafluoroethylene (PTFE), and/or poly imide (PI).

11. The functional battery separator of claim 1 wherein the bare separator component includes a non-woven based separator comprising one or more of: cellulose, lignin, polyethylene terephthalate (PET), polyester, polypropylene, cotton, nylon, and/or glass.

12. functional battery separator of claim 1 wherein the bare separator component comprises a paper-based separator, a ceramic based separator, or a composite based separator.

13. A lithium-ion battery cell, comprising:
a cathode element;
an anode element; and
a lithiophilic functional battery separator component comprises a bare separator component that is positioned in between the cathode element and the anode element and includes a lithiophilic coating containing particles of an applied functional lithiophilic solution.

14. The lithium-ion battery cell of claim 13 wherein the anode element comprises lithium metal.

15. The lithium-ion battery cell of claim 13 wherein the functional lithiophilic coating formed as a result of the applied functional lithiophilic solution drying on the surface of the bare separator component.

16. The lithium-ion battery cell of claim 15 wherein the particles of the lithiophilic coating originate from at least one functional lithiophilic material contained in the applied functional lithiophilic solution.

17. The lithium-ion battery cell of claim 16 wherein the at least one functional lithiophilic material includes lithium nitrate.

18. The lithium-ion battery cell of claim 17 wherein the at least one functional lithiophilic material includes a concentrations of 0.01M to 10M lithium nitrate in the solvent of the applied functional lithiophilic solution.

19. The lithium-ion battery cell of claim 16 wherein the at least one functional lithiophilic material includes one or more of: NaNO₃, CsNO₃, RbNO₃, LiNO₃, KNO₃, Ba(NO₃)₂, Sr(NO₃)₂, Mg(NO₃)₂, NH₄NO₃, Li₃AlN₂, Li₅SiN₃, Li₃BN₂, LiMgN, LiCaN, Li₂HfN₂, Li₃ScN₂, Li₂ZrN₂, Li₅TiN₃, Li₄TaN₃, Li₇TaN₄, Li₇NbN₄, Li₆WN₄, Li₇VN₄, and/or Li₁₈P₆N₁₆.
